(19) United States
(12) Patent Application Publication
(10) Pub. No.: US 2010/0246012 A1
(43) Pub. Date: Sep. 30, 2010

(54) OPITICAL ARTICLE AND PROCESS FOR PRODUCING THE SAME

(75) Inventors: Akiko TAKESHITA, Kami-ina-gun (JP); Shuho KOBAYASHI, Okaya-shi (JP)

Correspondence Address: OLIFF & BERRIDGE, PLC, P.O. BOX 320850, ALEXANDRIA, VA, 22320-4850, US

(73) Assignee: EPSON TOYOCOM CORPORATION, Tokyo (JP)

(21) Appl. No.: 12/731,664

(22) Filed: Mar. 25, 2010

(30) Foreign Application Priority Data
Mar. 27, 2009 (JP) 2009-078374
Jan. 21, 2010 (JP) 2010-010706

(51) Int. Cl. G02B 1/10; B29C 65/52

(52) U.S. Cl. 359/580; 156/60

(57) ABSTRACT

An optical article includes a plurality of light transmissive members and a plurality of optical functional films, wherein the plurality of light transmissive members are disposed to face one another; the optical functional film is disposed such that the optical functional film is sandwiched between the light transmissive members; a bonding layer that bonds a surface of the optical functional film to a surface of the light transmissive member is provided; the optical functional film is a multilayer film in which a plurality of low refractive index layers and a plurality of high refractive index layers are alternately arranged and a layer in contact with the side of the bonding layer is a high refractive index layer; and the bonding layer is a plasma-polymerized film having the same refractive index as that of the low refractive index layer.

### BACKGROUND

1. Technical Field

The present invention relates to an optical article in which a multilayer optical functional film is provided between a plurality of light transmissive members, for example, a prism, a polarization separation element, and other optical articles, and also relates to a process for producing the same.

2. Related Art

An optical article in which an optical functional film is formed between a plurality of optical members is used in an optical pickup, a liquid crystal projector, and other devices.

As such an optical article, for example, there are a prism in which a polarization separation film is provided as an optical functional film between four triangular prism-shaped members, a cross prism in which a dielectric multilayer film formed by alternately laminating a thin film of silicon dioxide (SiO₂) having a low refractive index and a thin film of tantalum oxide (Ta₂O₅) having a high refractive index is provided between the bottoms of two prisms (Patent Document 1: JP-A-2007-78779), and a polarization separation element (PS converter) in which a polarization separation film obtained by alternately laminating a thin film having a high refractive index and a thin film having a low refractive index is sandwiched between two optical members each having a reflection film therein, and the two optical members with the polarization separation film therebetween are laminated one after another, and a retardation plate is provided on the side of the light emission surface of the polarization separation film interposed between the optical members.

As described above, an optical article in which a multilayer optical functional film is provided between a pair of optical members is produced by various methods. As a related example, there is a method in which a dielectric multilayer film is formed on the bonding surface of one of a pair of prism glasses in the form of a substantially triangular prism, a silicon dioxide layer constituting the uppermost layer of the dielectric multilayer film is formed by sputtering, and a silicon dioxide layer is formed on the bonding surface of the other prism glass by sputtering (Patent Document 2: JP-A-2007-219195).

In the related example shown in Patent Document 2, the uppermost layer made of silicon dioxide of the dielectric multilayer film is formed by sputtering, and therefore, an additional process for forming the uppermost layer of silicon dioxide is needed other than a process for forming the dielectric multilayer film, and thus, the productivity is not good. In general, an optical article is constituted of a film which is unsuitable for bonding, and therefore, it is essential to provide a low refractive index layer of silicon dioxide or the like as the uppermost layer. Accordingly, in the related example shown in Patent Document 2, the silicon dioxide film cannot be omitted or replaced by another film.

Moreover, in order for the silicon dioxide layer to have a smooth surface, a prism glass which is an underlying material is required to have smoothness (surface accuracy), and therefore, from this point of view, the productivity is not good.

### SUMMARY

An advantage of some aspects of the invention is to provide an optical article capable of increasing the productivity and a process for producing the optical article.

### Application Example 1

An optical article according to application example 1 of the invention has a plurality of light transmissive members and a plurality of optical functional films, wherein the plurality of light transmissive members are disposed to face one another; the optical functional film is disposed such that the optical functional film is sandwiched between the light transmissive members; a bonding layer that bonds a surface of the optical functional film to a surface of the light transmissive member is provided; the optical functional film is a multilayer film in which a plurality of low refractive index layers and a plurality of high refractive index layers are alternately arranged and a layer in contact with the side of the bonding layer is a high refractive index layer; and the bonding layer is a plasma-polymerized film having the same refractive index as that of the low refractive index layer.

In this application example having the above-mentioned configuration, the optical functional film is formed on one of the light transmissive members and the plasma-polymerized film is formed on either one of the other light transmissive members and the optical functional film, and a plurality of light transmissive members are bonded to one another by interposing the optical functional film and the plasma-polymerized film therebetween.

In this application example, the outermost layer of the optical functional film is a high refractive index layer and the plasma-polymerized film having a low refractive index is formed thereon, and therefore, it is not necessary to additionally provide a low refractive index layer which is formed as the outermost layer in the film structure of the related optical functional film, and thus, the productivity of the optical article is increased.

### Application Example 2

Application example 2 of the invention is directed to the optical article according to the above application example, wherein the plurality of light transmissive members are in the form of a triangular prism.

In this application example having this configuration, the productivity of a polarization separation element in which the optical functional film is a polarization separation film can be increased.

### Application Example 3

Application example 3 of the invention is directed to the optical article according to the above application example, wherein a bonded body of the plurality of light transmissive members disposed to face one another is in the form of a plate, and the bonded body has a light incidence surface and a light emission surface which are in parallel to each other, and on the light emission surface, a retardation plate is selectively provided.

In this application example having this configuration, the productivity of a polarization conversion element which converts incident light into polarization light can be increased.

### Application Example 4

Application example 4 of the invention is directed to a process for producing an optical article having a plurality of light transmissive members, an optical functional film interposed between the light transmissive members, and a bonding layer that bonds a surface of the optical functional film to a surface of the light transmissive member. The process includes an optical functional film forming step of alternately forming a low refractive index layer having a low refractive index and a high refractive index layer having a high refractive index on a surface of at least one of the plurality of light transmissive members, with the proviso that the outermost layer is formed of a high refractive index layer; a bonding layer forming step of forming a plasma-polymerized film having the same refractive index as that of the low refractive index layer on a surface of at least one of the plurality of light transmissive members and the optical functional film; a surface activating step of activating the plasma-polymerized film formed in the bonding layer forming step; and a bonding step of bonding the plurality of light transmissive members, the optical functional film, and the plasma-polymerized film to one another by interposing the optical functional film and the plasma-polymerized film between the light transmissive members.

In this application example having this configuration, a production process capable of increasing the productivity of an optical article can be provided.

### Application Example 5

Application example 5 of the invention is directed to the process for producing an optical article according to the above application example, wherein in the bonding layer forming step, the plasma-polymerized film is formed only on the optical functional film formed in the optical functional film forming step.

In this application example having this configuration, the plasma-polymerized film is formed only on the optical functional film, and this plasma-polymerized film is bonded to one of the light transmissive members. The density of the optical functional film is low, and therefore, the surface accuracy is slightly decreased. However, by forming the plasma-polymerized film on this optical functional film and bonding this plasma-polymerized film and the bonding surface in a mirror surface state of one of a first light transmissive member and a second light transmissive member to each other, a contact area is increased, resulting in increasing an intermolecular force. Accordingly, it becomes possible to omit a pressing operation in the bonding step, and the production steps can be simplified.

### BRIEF DESCRIPTION OF THE DRAWINGS

The invention will be described with reference to the accompanying drawings, wherein like numbers reference like elements.

FIG. 1 is a view showing an end face of an optical article according to a first embodiment of the invention.

FIGS. 2A and 2B are views each showing a main part of FIG. 1.

FIG. 3 is a schematic view of a plasma polymerization apparatus to be used in the first embodiment.

FIGS. 4A to 4C are schematic views illustrating a procedure for forming a plasma-polymerized film.

FIGS. 5A and 5B are schematic views illustrating a step of activating the plasma-polymerized film.

FIGS. 6A and 6B are schematic views illustrating a bonding step.

FIGS. 7A and 7B are schematic views illustrating a cutting step.

FIGS. 8A to 8C are schematic views illustrating an assembling step.

FIG. 9 is a view showing an end face of an optical article according to a second embodiment of the invention.

FIG. 10 is a cross-sectional view showing a main part of FIG. 9.

FIG. 11 as a schematic view of a plasma polymerization apparatus to be used in the second embodiment.

FIGS. 12A to 12D are schematic views illustrating a procedure for forming a plasma-polymerized film.

FIGS. 13A to 13D are schematic views illustrating a bonding step and a pressing step.

FIG. 14 is a graph showing a transmittance through a polarization separation film in which the outermost layer is formed of silicon dioxide.

FIG. 15 is a graph showing a transmittance through a polarization separation film in which the outermost layer is formed of a plasma-polymerized film.

FIG. 16 is a graph showing the transmittance shown in FIG. 14 and the transmittance shown in FIG. 15 together.

### DESCRIPTION OF EXEMPLARY EMBODIMENTS

Hereinafter, embodiments of the invention will be described with reference to the attached drawings. Here, in the description of the respective embodiments, the same symbols are assigned to the same constituent elements and the description thereof will be omitted or simplified.

### First Embodiment

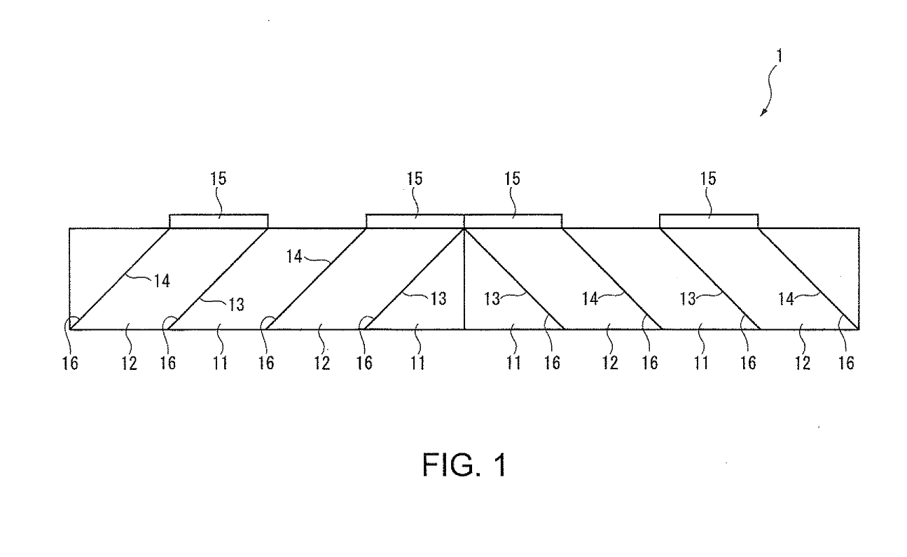

A first embodiment of the invention will be described with reference to FIG. 1 to FIG. 8C. In the first embodiment, a polarization separation element 1 called a PS converter is exemplified as the optical article. This polarization separation element 1 is used in, for example, a liquid crystal projector device.

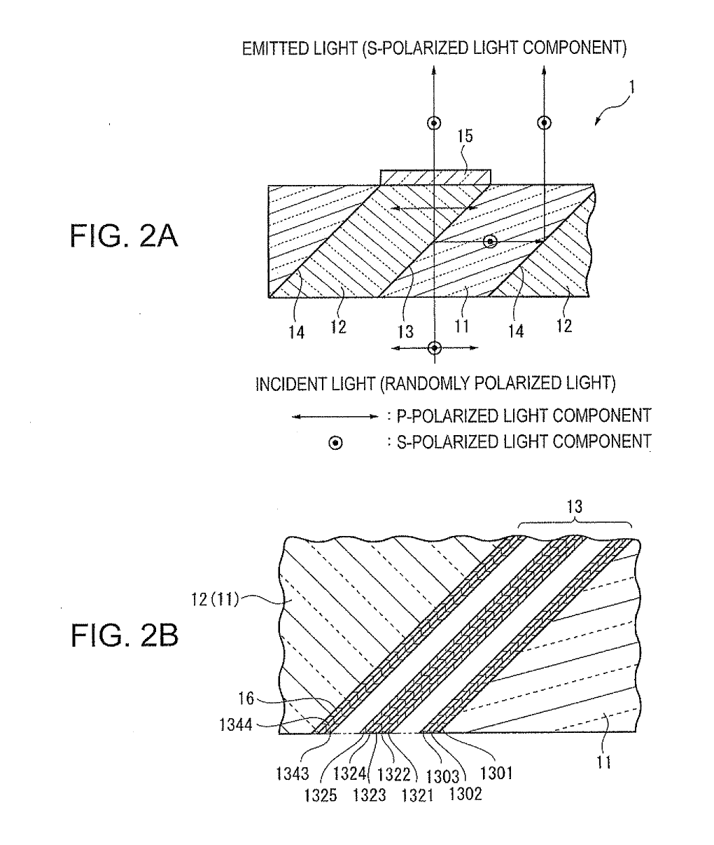

FIG. 1 is a view showing an end face of the polarization separation element 1 according to the first embodiment and FIGS. 2A and 2B are cross-sectional views each showing a main part of FIG. 1.

In FIG. 1, the polarization separation element 1 is a plate-shaped member in which a plurality of first light transmissive members 11 and a plurality of second light transmissive members 12 are alternately arranged by interposing an optical functional film therebetween. In this embodiment, as the optical functional film, a polarization separation film 13 and a reflection film 14 are used, and the polarization separation film 13 and the reflection film 14 are alternately arranged. On the side of the light emission surface of the polarization separation film 13 interposed between the first light transmissive members 11 and the second light transmissive members 12, a retardation plate 15 is selectively provided.

The first light transmissive members 11 and the second light transmissive members 12 are arranged such that a plane on the light incidence side and a plane on the light emission side are in parallel to each other and the reflection film 14 and the polarization separation film 13 are arranged in parallel to each other at an angle with respect to these planes of 45°. In this embodiment, the polarization separation element 1 has a symmetric structure, and in the center of the polarization separation element 1, the retardation plates 15 are arranged side by side on the light emission surface side.

The first light transmissive member 11 and the second light transmissive member 12 which are the plurality of light transmissive members are formed of a glass such as an optical glass (such as BK7), a white plate glass, a borosilicate glass, or a blue plate glass.

As shown in FIG. 2A, the polarization separation film 13 has a function of separating incident bundle of light rays (s-polarized light and p-polarized light) into s-polarized partial light beams (s-polarized light) and p-polarized partial light beams (p-polarized light), and reflecting the s-polarized light and transmitting the p-polarized light. The reflection film 14 has a function of reflecting the incident s-polarized light as such.

As shown in FIG. 2B, the polarization separation film 13 is a dielectric multilayer film constituted of an even number, for example, forty-four layers. When the layer disposed on the side of the first light transmissive member 11 is designated as a first layer 1301, the other layers from the layer next to the first layer 1301 to the layer on the side of the second light transmissive member 12 are designated as a second layer 1302, a third layer 1303, . . . , a twenty-first layer 1321, a twenty-second layer 1322, a twenty-third layer 1323, a twenty-fourth layer 1324, a twenty-fifth layer 1325, . . . , a forty-third layer 1343, and a forty-fourth layer 1344, respectively. Among these layers, the odd-numbered layers, for example, the first layer 1301, the third layer 1303, the twenty-first layer 1321, the twenty-third layer 1323, the twenty-fifth layer 1325, and the forty-third layer 1343 are each formed as a low refractive index layer made mainly of silicon dioxide (SiO₂), and the even-numbered layers, for example, the second layer 1302, the fourth layer 1304, the twenty-second layer 1322, the twenty-fourth layer 1324, and the forty-fourth layer 1344 are each formed as a high refractive index layer made mainly of titanium dioxide (TiO₂). That is, in the first embodiment, a low refractive index layer and a high refractive index layer are alternately laminated to each other, and the outermost layer on the side of the second light transmissive member 12 is formed of the high refractive index layer.

Between the forty-fourth layer 1344 which is the outermost layer and the second light transmissive member 12, the bonding layer 16 is provided. This bonding layer 16 is formed of a plasma-polymerized film, and this plasma-polymerized film has the same refractive index as that of silicon dioxide constituting the low refractive index layer.

The reflection film 14 is a dielectric multilayer film constituted of an even number of layers in the same manner as the polarization separation film 13 shown in FIG. 2B and has a structure in which, for example, a low refractive index layer made of silicon dioxide and a high refractive index layer made mainly of titanium dioxide are alternately laminated to each other. On the uppermost layer of the reflection film 14, the bonding layer 16 is provided. This bonding layer 16 is formed of a plasma-polymerized film, and this plasma-polymerized film has the same refractive index as that of silicon dioxide constituting the low refractive index layer.

The retardation plate 15 is a strip-shaped ½ wavelength plate, and the width dimension thereof corresponds to the dimension between the polarization separation film 13 and the reflection film 14. The retardation plate 15 is formed of quartz composed of single crystal of SiO₂. This quartz may be either artificial quartz or natural quartz.

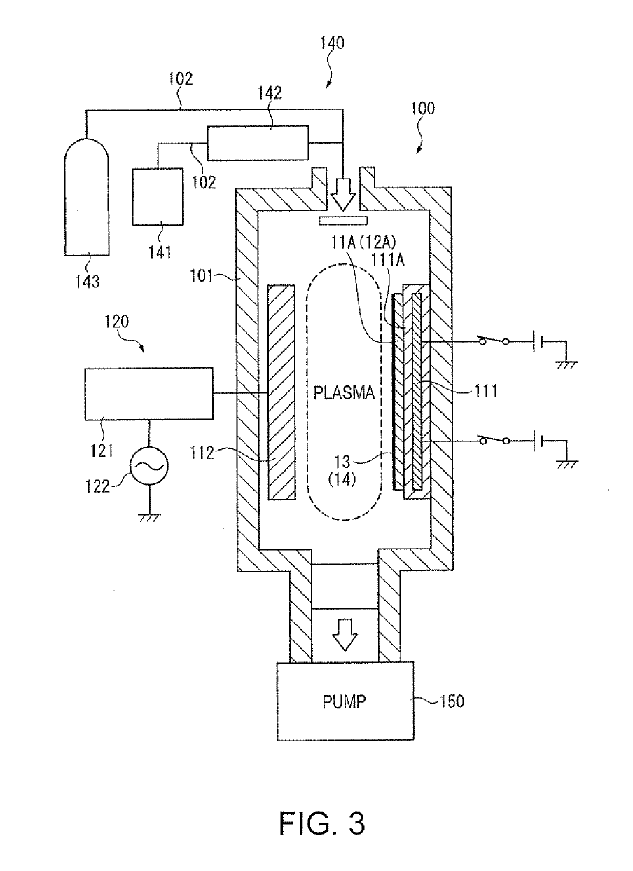

Subsequently, a process for producing an optical article according to the first embodiment will be described with reference to FIG. 3 to FIG. 8C.

### Optical Functional Film Forming Step

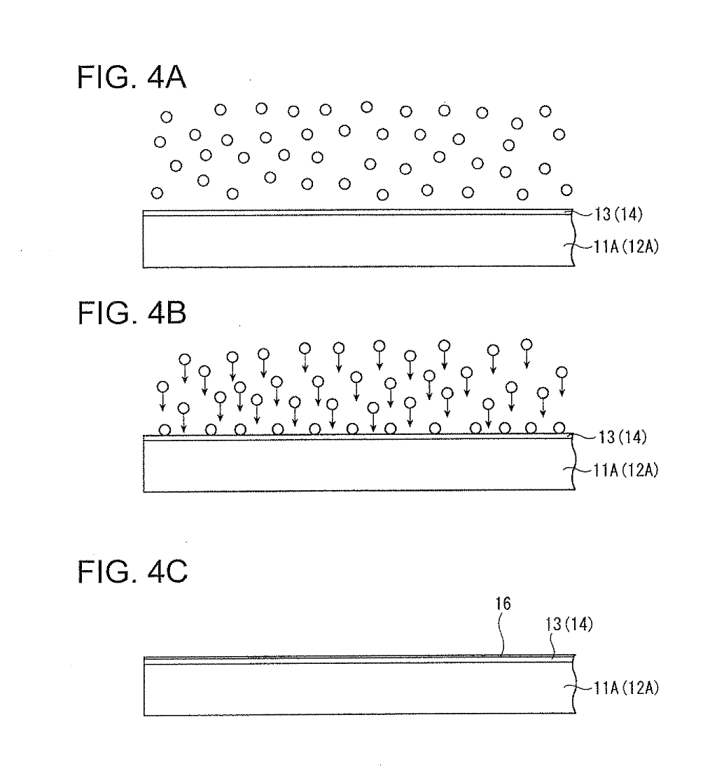

A strip-shaped optical block 11A for forming the first light transmissive member 11 and a strip-shaped optical block 12A for forming the second light transmissive member 12 (see FIGS. 4A to 4C) are provided in advance. The material of these strip-shaped optical blocks 11A and 12A are the same as that of the first light transmissive member 11 and the second light transmissive member 12. The plate faces of the strip-shaped optical blocks 11A and 12A are smoothly polished to a mirror finish.

On one surface of the strip-shaped optical block 11A, the polarization separation film 13 is formed. Due to this, first, a low refractive index layer is formed as a first layer on one plane of the strip-shaped optical block 11A, and thereon, a high refractive index layer is formed. The low refractive index layer and the high refractive index layer are alternately formed thereon, with the proviso that the outermost layer is formed of the high refractive index layer. The formation of these layers is performed by a method such as vapor deposition in the same manner as in the related art.

### Polymerized Film Forming Step

The bonding layer 16 constituted of a plasma-polymerized film is formed on the polarization separation film 13 provided on the strip-shaped optical block 11A using a plasma polymerization apparatus shown in FIG. 3.

FIG. 3 is a schematic view of a plasma polymerization apparatus. Since the detailed structure of this plasma polymerization apparatus is described in JP-A-2006-307873, the outline of the apparatus will be described below.

In FIG. 3, a plasma polymerization apparatus 100 has a structure of having a chamber 101, a first electrode 111 and a second electrode 112 each of which is provided in the inside of this chamber 101, a power supply circuit 120 which applies a high-frequency voltage between the first electrode 111 and the second electrode 112, a gas supply unit 140 which supplies a gas to the inside of the chamber 101, and an exhaust pump 150 which exhausts a gas in the inside of the chamber 101. The first electrode 111 has a support body 111A which supports the strip-shaped optical block 11A.

The power supply circuit 120 is provided with a matching box 121 and a high-frequency power source 122.

The gas supply unit 140 is provided with a liquid storage section 141 which stores a liquid membrane material, a vaporization device 142 which vaporizes the liquid membrane material to convert the material into a raw material gas, and a gas cylinder 143 which stores a carrier gas.

The liquid storage section 141, the vaporization device 142, the gas cylinder 143, and the chamber 101 are interconnected to one another by a pipe 102, and constitute a structure such that a mixed gas of the gaseous film material and the carrier gas is supplied to the inside of the chamber 101.

Examples of the raw material gas include organosiloxanes such as methylsiloxane and hexamethyldisiloxane; organometallic compounds such as trimethyl gallium, triethyl gallium, trimethyl aluminum, triethyl aluminum, triisobutyl aluminum, trimethyl indium, triethyl indium, trimethyl zinc, and triethyl zinc; a variety of hydrocarbon compounds, and a variety of fluorine compounds.

The plasma-polymerized film obtained by using such a raw material gas is constituted of a material obtained by polymerizing such a raw material (polymerized material), i.e., a polyorganosiloxane, an organometallic polymer, a hydrocarbon polymer, a fluorine polymer, or the like.

Subsequently, a procedure for forming the plasma-polymerized film will be described with reference to FIGS. 4A to 4C.

As shown in FIGS. 4A to 4C, a plasma-polymerized film is formed on the uppermost layer of the polarization separation film 13 provided on the strip-shaped optical block 11A.

In the polymerized film forming step, by operating the gas supply unit 140, a mixed gas of a raw material gas and a carrier gas is supplied to the inside of the chamber 101. The chamber 101 is filled with the supplied mixed gas, and as shown in FIG. 4A, the mixed gas is exposed to the uppermost layer of the polarization separation film 13 provided on the strip-shaped optical block 11A.

By applying a high-frequency voltage between the first electrode 111 and the second electrode 112, the gas molecules present between the first electrode 111 and the second electrode 112 are ionized and plasma is generated. Due to the energy of the plasma, the molecules in the raw material gas are decomposed. The decomposed molecules are recombined to effect polymerization, and the polymerized material is attached and deposited on the surface of the uppermost layer of the polarization separation film 13 as shown in FIG. 4B. In this manner, as shown in FIG. 4C, a plasma-polymerized film which becomes the bonding layer 16 is formed on the uppermost layer of the polarization separation film 13. The composition of the mixed gas is formulated such that the resulting plasma-polymerized film has the same refractive index as that of silicon dioxide constituting the low refractive index layer.

### Surface Activating Step

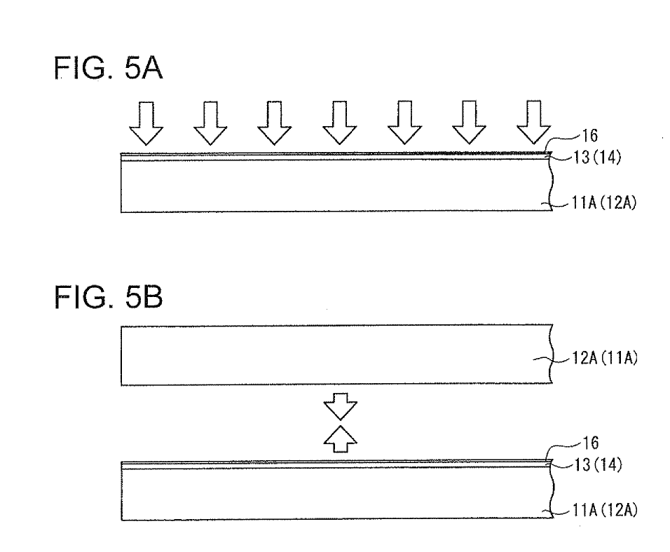

Thereafter, as shown in FIG. 5A, the surface of the plasma-polymerized film constituting the bonding layer 16 is activated.

In the surface activating step, for example, a method of irradiation with plasma, a method of contacting with an ozone gas, a method of treatment with ozone water, a method of treatment with an alkali, or the like can be used.

### Bonding Step

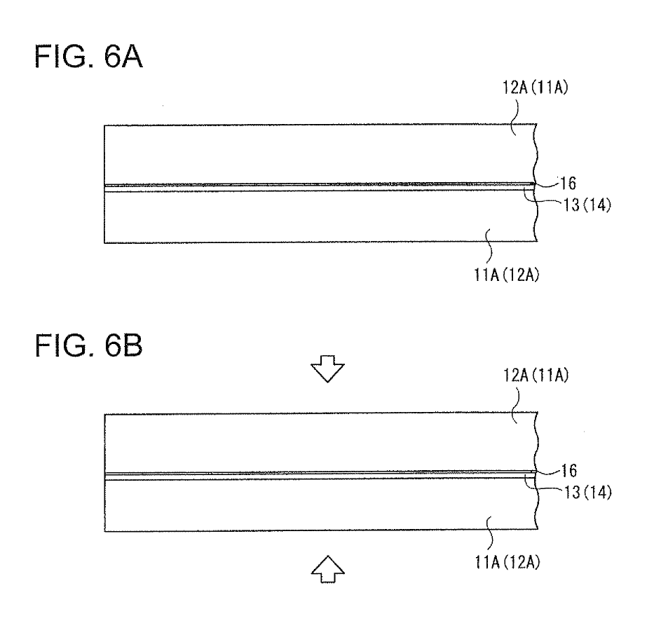

The bonding layer 16 constituted of the plasma-polymerized film formed on the polarization separation film 13 on the strip-shaped optical block 11A and the strip-shaped optical block 12A are bonded to each other. Due to this, as shown in FIG. 5B, the strip-shaped optical block 11A and the strip-shaped optical block 12A adjacent to each other are allowed to face each other in a state where the polarization separation film 13 and the bonding layer 16 are interposed therebetween. Further, as shown in FIG. 6A, the plane of the bonding layer 16 provided on the strip-shaped optical block 11A and the plane of the strip-shaped optical block 12A are bonded to each other. The bonding layer 16 is formed of a plasma-polymerized film, and to the surface thereof, the strip-shaped optical block 12A whose plane face has been smoothly polished to a mirror finish is bonded. Here, a contact area between the mirror-finished plane of the strip-shaped optical block 12A and the plasma-polymerized film is increased and a so-called “wetting” layer is likely to be formed. As the area of the “wetting” layer is large, an intermolecular force becomes large, thereby increasing the density associated with bonding between the plasma-polymerized film and the strip-shaped optical block 12A, and thus, a bonding force is increased. Incidentally, as shown in FIG. 6B, according to need, the strip-shaped optical block 11A and the strip-shaped optical block 12A adjacent to each other may be pressed to each other, however, in this embodiment, a large bonding force can be obtained as described above, and therefore, this pressing step is basically not needed.

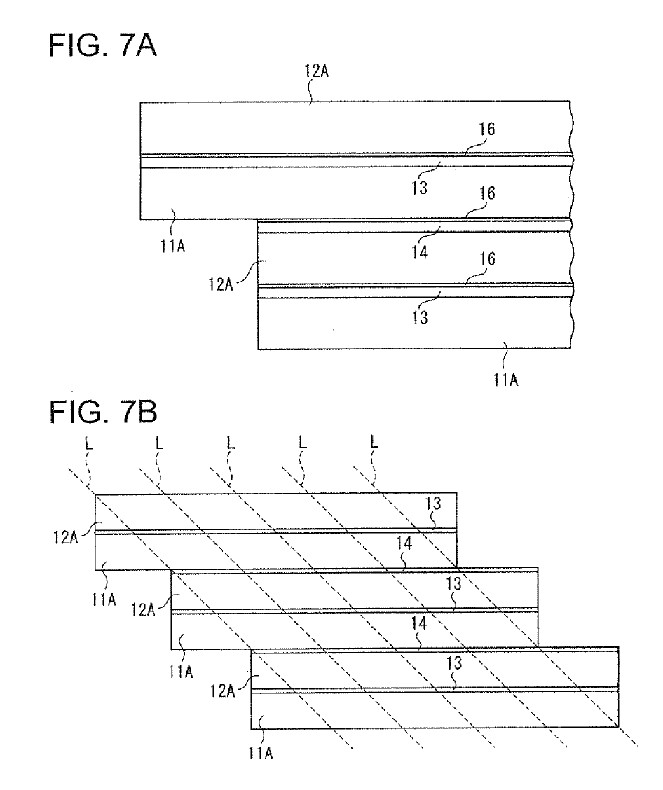

Incidentally, in this embodiment, the reflection film 14 is formed on the strip-shaped optical blocks 11A and 12A provided with the polarization separation film 13 and the bonding layer 16 therebetween. To be more specific, on the plane of the strip-shaped optical block 12A of the strip-shaped optical blocks 11A and 12A, the reflection film 14 is formed by vapor deposition or the like in the same manner as the above-mentioned method for forming the polarization separation film 13, and then, the bonding layer 16 which is a plasma-polymerized film is formed such that the bonding layer 16 comes in contact with the uppermost layer of the reflection film 14. Then, to this bonding layer 16, the plane of the strip-shaped optical block 11A of the strip-shaped optical blocks 11A and 12A is bonded. This bonding is performed in a state where the position of the end of the strip-shaped optical blocks 11A and 12A in which the polarization separation film 13 is bonded therebetween by way of the bonding layer 16 is shifted for every two blocks 11A and 12A (see FIG. 7A).

### Cutting Step

A material obtained by laminating a plurality of the strip-shaped optical blocks 11A and 12A is cut into a predetermined shape.

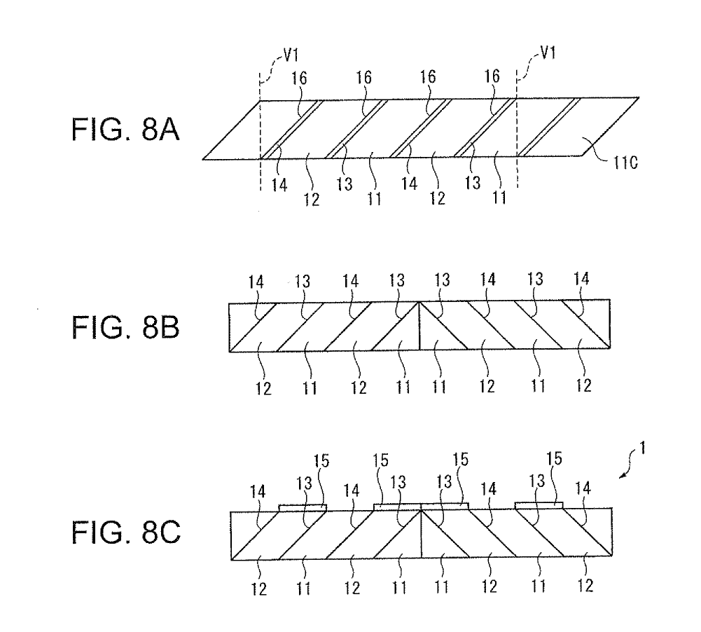

As shown in FIG. 7A, the strip-shaped optical blocks 11A and 12A in which the polarization separation film 13 is bonded therebetween by way of the bonding layer 16 are laminated in a state where the position of the end thereof is shifted. As shown in FIG. 7B, the material obtained by laminating the strip-shaped optical blocks 11A and 12A is cut at predetermined intervals along the dotted line indicated by L which is tilted at an angle of 45° with respect to the plane of the strip-shaped optical blocks 11A and 12A. One block 11C obtained by cutting as described above is shown in FIG. 8A.

As shown in FIG. 8A, the block 11C has an end face in the form of a parallelogram. Further, the block 11C has a structure in which the polarization separation film 13 and the reflection film 14 are arranged at predetermined intervals. Thereafter, the block 11C is cut at a predetermined position along the dotted line indicated by V1 which is perpendicular to the plane of the block 11C.

### Retardation Plate Installing Step

As shown in FIG. 8B, the blocks 11C obtained by cutting are arranged side by side and bonded to each other, and as shown in FIG. 8C, a retardation plate 15 is selectively bonded and fixed on the side of the light emission surface of the polarization separation film 13 of these blocks 11C. By doing this, a polarization separation element 1 is formed.

Two polarization separation films having different outermost layers were prepared and the transmittance of p-polarized light through the films was measured. One of the polarization separation films was a multilayer film having a silicon dioxide layer as the outermost layer, and the other polarization separation film was a multilayer film having a plasma-polymerized film as the outermost layer. As for the measurement of the transmittance of p-polarized light, by using a spectrophotometer manufactured by Hitachi Co., Ltd. and a polarizer, the ratio of the transmitted p-polarized light to the incident p-polarized light to a sample was measured.

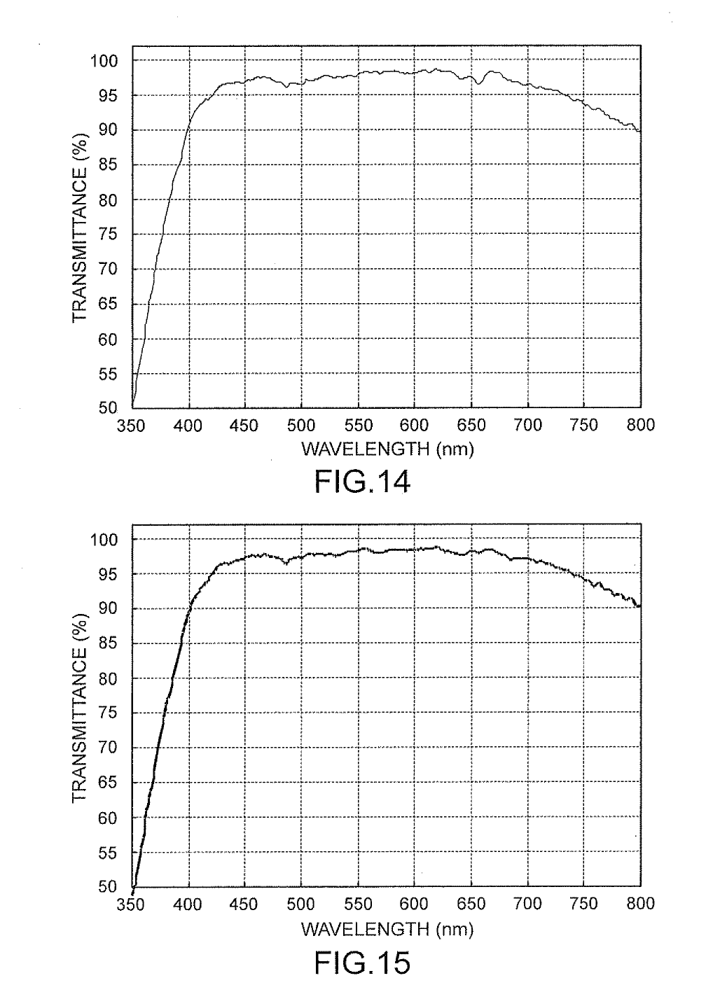

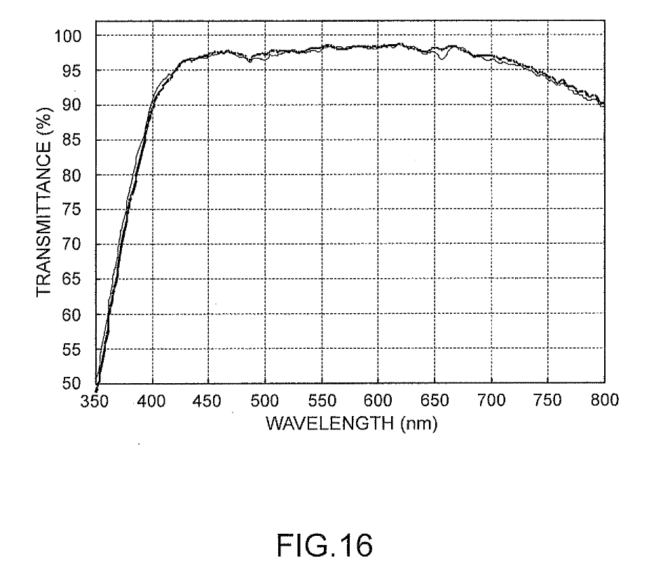

FIG. 14 is a graph showing the transmittance of p-polarized light through the multilayer film in which the outermost layer is a silicon dioxide layer. FIG. 15 is a graph showing the transmittance of p-polarized light through the multilayer film in which the outermost layer is a plasma-polymerized film. FIG. 16 is a graph showing the transmittances of p-polarized light through these two multilayer films together. It is shown that the multilayer film having a plasma-polymerized film as the outermost layer has optical characteristics equivalent to those of the related multilayer film while having a function of the bonding layer between the light transmissive members.

Accordingly, in the first embodiment, the following operation effects can be obtained.

(1) A polarization separation film 13 in which a high refractive index layer and a low refractive index layer were alternately laminated to each other, with the proviso that the uppermost layer was formed of the high refractive index layer was formed on a first light transmissive member 11, and a bonding layer 16 was provided between the polarization separation film 13 and a second light transmissive member 12. Further, a reflection film 14 in which a high refractive index layer and a low refractive index layer were alternately laminated to each other, with the proviso that the uppermost layer was formed of the high refractive index layer was formed on the second light transmissive member 12, and the bonding layer 16 was provided between the reflection film 14 and the first light transmissive member 11. In this connection, these bonding layers 16 were each formed of a plasma-polymerized film having the same refractive index as that of the low refractive index layer. Accordingly, the film constituted of the polarization separation film 13 and the bonding layer 16 has the same film structure as that of the related polarization separation film, and in a similar way, the film constituted of the reflection film 14 and the bonding layer 16 has the same film structure as that of the related reflection film. Therefore, the optical characteristics of the polarization separation film 13 or the reflection film 14 are not deteriorated. Moreover, since the uppermost layer formed of the low refractive index layer in the related film structure turns out to be replaced by the bonding layer 16, the step of forming the low refractive index layer constituting the uppermost layer is omitted when the polarization separation film or the reflection film is formed, and therefore, the productivity of the polarization separation element 1 is increased.

(2) The low refractive index layer of the polarization separation film 13 or the reflection film 14 was formed of silicon dioxide, and the bonding layer 16 was formed of the plasma-polymerized film having the same refractive index as that of the silicon dioxide. Accordingly, the intermolecular distance between the plasma-polymerized film having the same refractive index as that of silicon dioxide and the plane of the first light transmissive member 11 or the second light transmissive member 12 is made appropriate, and an intermolecular attractive force occurs therebetween, and therefore, a strong bonding can be obtained.

(3) The plasma-polymerized film was formed only on the polarization separation film 13 or the reflection film 14, and this plasma-polymerized film is bonded to the mirror-finished plane of the second light transmissive member 12 or the first light transmissive member 11 which has higher surface accuracy than the polarization separation film or the reflection film, and therefore, there are a lot of contact points and a contact area is increased, resulting in increasing an intermolecular force. Accordingly, it becomes possible to omit a pressing operation in the bonding step, and the production steps can be simplified.

### Second Embodiment

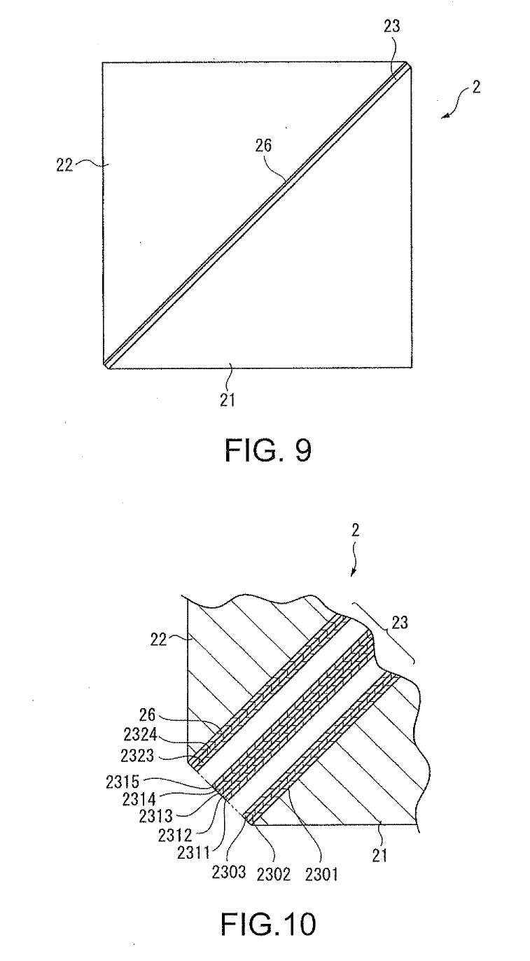

Subsequently, a second embodiment of the invention will be described with reference to FIG. 9 to FIG. 13D.

In the second embodiment, a prism 2 is exemplified as the optical article. The prism 2 is used as a polarization separation element for an optical pickup.

FIG. 9 is a view showing an end face of the prism 2, and FIG. 10 is a cross-sectional view showing a main part of FIG. 9.

In FIG. 9 and FIG. 10, the prism 2 has a structure of having a first light transmissive member 21 on the light incidence side, a second light transmissive member 22 on the light emission side, and an optical functional film 23 interposed between the first light transmissive member 21 and the second light transmissive member 22.

The first light transmissive member 21 and the second light transmissive member 22 are each a triangular prism-shaped member having a right-angled triangular end face. The shape and the length of the end faces of both members are the same.

The first light transmissive member 21 and the second light transmissive member 22 are formed of a glass such as an optical glass (such as BK7), a white plate glass, a borosilicate glass, or a blue plate glass, and are made of the same material.

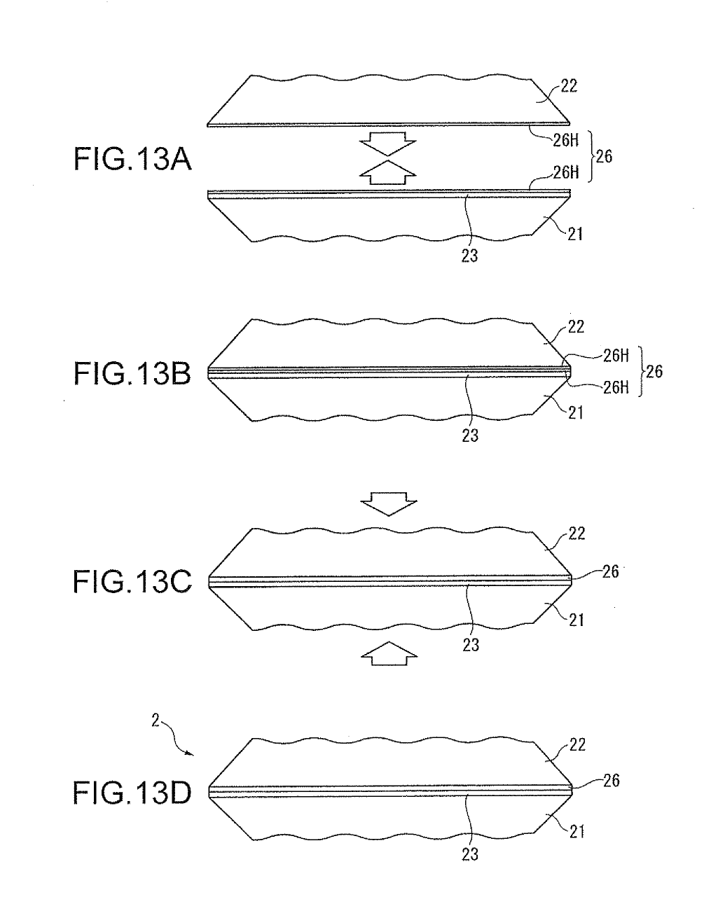

The optical functional film 23 is a polarization separation film having a polarization separation action and is constituted of twenty-four layers. When the layer disposed on the side of the bottom of the first light transmissive member 21 is designated as a first layer 2301, the other layers from the layer next to the first layer 2301 to the layer on the side of the second light transmissive member 22 are designated as a second layer 2302, a third layer 2303, . . . , an eleventh layer 2311, a twelfth layer 2312, a thirteenth layer 2313, a fourteenth layer 2314, a fifteenth layer 2315, . . . , a twenty-third layer 2323, and a twenty-fourth layer 2324, respectively. Among these layers, the odd-numbered layers are each made mainly of silicon dioxide (SiO₂) which is a low refractive index layer material, and the even-numbered layers are each made mainly of titanium dioxide (TiO₂) which is a high refractive index layer material. That is, in this embodiment, a high refractive index layer and a low refractive index layer are alternately laminated to each other, and the twenty-fourth layer 2324 which is the uppermost layer is the high refractive index layer. A bonding layer 26 is provided between the twenty-fourth layer 2324 and the second light transmissive member 22. The bonding layer 26 is formed of a plasma-polymerized film, and the plasma-polymerized film has the same refractive index as that of silicon dioxide constituting the low refractive index layer. In this embodiment, the bonding layer 26 is formed by combining two plasma-polymerized films 26H together (see FIGS. 13A to 13D).

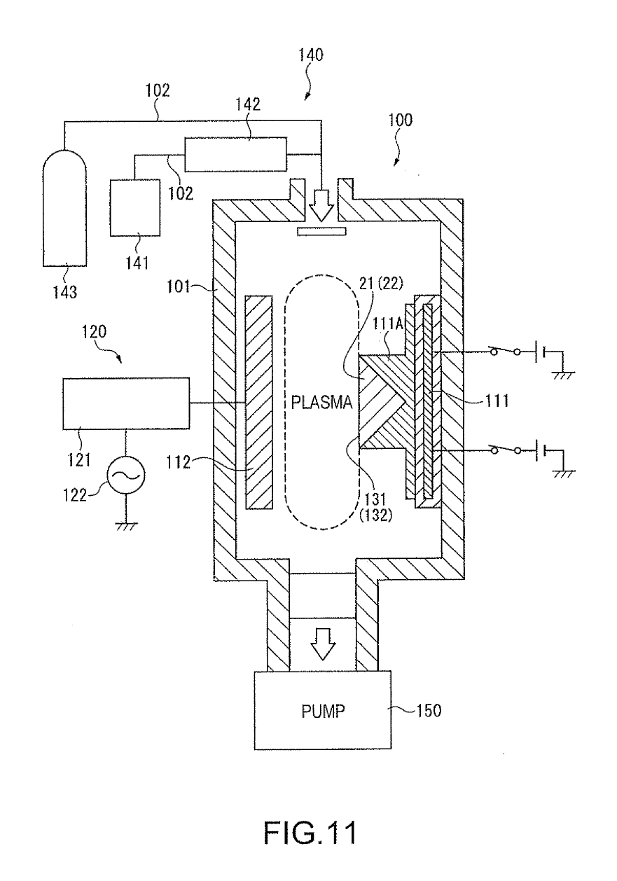

Subsequently, a process for producing the optical article according to the second embodiment will be described with reference to FIG. 11 to FIG. 13D.

### Optical Functional Film Forming Step

The twenty-four layers from the first layer 2301 to the twenty-fourth layer 2324 are formed on the first light transmissive member 21 using a method similar to that used in the related art such as vacuum vapor deposition, ion-assisted deposition, an ion-plating method, or a sputtering method.

### Polymerized Film Forming Step

FIG. 11 is a schematic view of a plasma polymerization apparatus to be used in the second embodiment.

A plasma polymerization apparatus 100 shown in FIG. 11 has the same structure as that of the plasma polymerization apparatus 100 to be used in the first embodiment except that the structure of the support body 111A is different. That is, in the plasma polymerization apparatus 100 shown in FIG. 11, the support body 111A has a triangular groove-shaped part which supports the oblique side portion of the first light transmissive member 21 or the second light transmissive member 22.

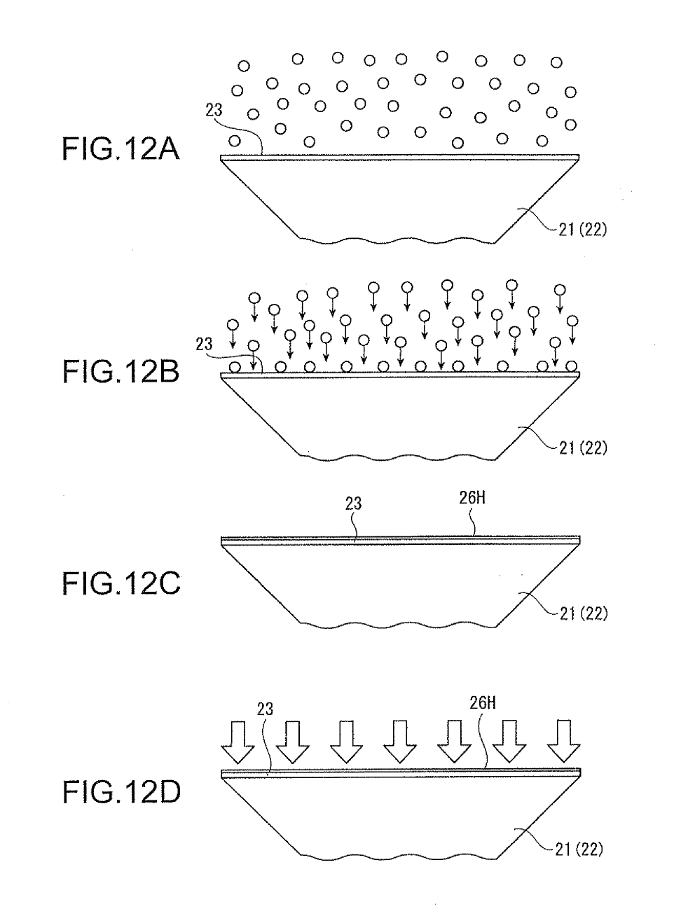

A procedure for forming the plasma-polymerized film 26H will be described with reference to FIGS. 12A to 12C.

As shown in FIGS. 12A to 12C, a plasma-polymerized film 26H is formed on both of the optical functional film 23 provided on the first light transmissive member 21 and the second light transmissive member 22.

In this polymerized film forming step, when a mixed gas of a raw material gas and a carrier gas is supplied to the inside of the chamber 101, as shown in FIG. 12A, the mixed gas is exposed to the optical functional film 23 provided on the first light transmissive member 21 or the second light transmissive member 22. By applying a high-frequency voltage between the first electrode 111 and the second electrode 112, plasma is generated. Due to the energy of the plasma, the molecules in the raw material gas are decomposed. The decomposed molecules are recombined to effect polymerization, and the polymerized material is attached and deposited on the surface of the optical functional film 23 provided on the first light transmissive member 21 and the second light transmissive member 22 as shown in FIG. 12B. In this manner, as shown in FIG. 12C, the plasma-polymerized film 26H is formed on the optical functional film 23 provided on the first light transmissive member 21 and the second light transmissive member 22.

### Surface Activating Step

Thereafter, as shown in FIG. 12D, the surface of the plasma-polymerized film 26H is activated. The activation method is the same as described in the first embodiment.

### Bonding Step

In the bonding step, the plasma-polymerized film 26H formed on the optical functional film 23 and the plasma-polymerized film 26H formed on the second light transmissive member 22 are bonded and combined with each other to form the bonding layer 26. Therefore, as shown in FIGS. 13A and 13B, the first light transmissive member 21 and the second light transmissive member 22 are pressed to each other in a state where the plasma-polymerized films 26H are allowed to face each other. By bonding the plasma-polymerized films 26H to each other, these films are combined with each other.

In this embodiment, as shown in FIG. 13C, after the bonding step, according to need, the first light transmissive member 21 and the second light transmissive member 22 are pressed to each other (pressing step). By doing this, as shown in FIG. 13D, a prism 2 is produced.

After the first light transmissive member 21 and the second light transmissive member 22 are pressed to each other, these members are heated (heating step). By heating the prism 2, a bonding strength can be increased.

The heating step is provided according to need, and the heating temperature is from 25 to 250° C., preferably from 50 to 100° C.

Accordingly, in the second embodiment, the same effects as described in the above-mentioned items (1) and (2) in the first embodiment can be obtained.

The invention is not limited to the above-mentioned embodiments and includes modifications shown below within a scope that can obtain the advantages of the invention.

For example, in the above-mentioned embodiments, the plasma-polymerized film constituting the bonding layer 16 or 26 is made of silicon dioxide (SiO₂), however, in the invention, the plasma-polymerized film may be formed using a material other than silicon dioxide. To be more specific, in the invention, the bonding layer 16 or 26 has the same refractive index as that of the low refractive index layer of the polarization separation film 13, the reflection film 14, or the optical functional film 23, and therefore, the material of the plasma-polymerized film is determined according to the film structure of the polarization separation film 13, the reflection film 14, or the optical functional film 23. For example, in the case of a polarization separation film in which a high refractive index layer of magnesium oxide (MgO having a refractive index of 1.73) and a low refractive index layer of magnesium fluoride (MgF₂ having a refractive index of 1.38) are alternately laminated to each other, the material of the plasma-polymerized film constituting the bonding layer is determined such that the resulting plasma-polymerized film has the same refractive index as that of magnesium fluoride constituting the low refractive index layer.

Further, in the above-mentioned embodiments, the first light transmissive members 11 and 21 and the second light transmissive members 12 and 22 are formed of a glass, however, in the invention, they may be formed of a material other than a glass, for example, a transparent plastic material such as a polycarbonate or acrylic plastic material.

Further, in the first embodiment, the bonding layer 16 which is a plasma-polymerized film is formed only on the polarization separation film 13 and the reflection film 14, however, this plasma-polymerized film may be formed only on the second light transmissive member 12 and the first light transmissive member 11, and further, it may be formed on all of the polarization separation film 13, the reflection film 14, the second light transmissive member 12, and the first light transmissive member 11. Meanwhile, in the second embodiment, the plasma-polymerized film 26H is formed on both of the optical functional film 23 and the second light transmissive member 22, however, it may be formed on either one of the optical functional film 23 and the second light transmissive member 22.

Further, in the invention, the optical article can be used in an optical device such as a camera other than an optical pickup or a liquid crystal projector.

The invention can be applied to an optical article to be used in an optical pickup, a liquid crystal projector, and other devices.

The entire disclosure of Japanese Patent Application Nos: 2009-078374, filed Mar. 27, 2009, 2010-010706 and filed Jan. 21, 2010 are expressly incorporated by reference herein.

What is claimed is:

1. An optical article, comprising a plurality of light transmissive members and a plurality of optical functional films, wherein
the plurality of light transmissive members are disposed to face one another;
the optical functional film is disposed such that the optical functional film is sandwiched between the light transmissive members;
a bonding layer that bonds a surface of the optical functional film to a surface of the light transmissive member is provided;
the optical functional film is a multilayer film in which a plurality of low refractive index layers and a plurality of high refractive index layers are alternately arranged and a layer in contact with the side of the bonding layer is a high refractive index layer; and
the bonding layer is a plasma-polymerized film having the same refractive index as that of the low refractive index layer.

2. The optical article according to claim 1, wherein the plurality of light transmissive members are in the form of a triangular prism.

3. The optical article according to claim 2, wherein a bonded body of the plurality of light transmissive members disposed to face one another is in the form of a plate, the bonded body has a light incidence surface and a light emission surface which are in parallel to each other, and on the light emission surface, a retardation plate is selectively provided.

4. A process for producing an optical article having a plurality of light transmissive members, an optical functional film interposed between the light transmissive members, and a bonding layer that bonds a surface of the optical functional film to a surface of the light transmissive member, comprising:
an optical functional film forming step of alternately forming a low refractive index layer having a low refractive index and a high refractive index layer having a high refractive index on a surface of at least one of the plurality of light transmissive members, with the proviso that the outermost layer is formed of a high refractive index layer;
a bonding layer forming step of forming a plasma-polymerized film having the same refractive index as that of the low refractive index layer on a surface of at least one of the plurality of light transmissive members and the optical functional film;
a surface activating step of activating the plasma-polymerized film formed in the bonding layer forming step; and
a bonding step of bonding the plurality of light transmissive members, the optical functional film, and the plasma-polymerized film to one another by interposing the optical functional film and the plasma-polymerized film between the light transmissive members.

5. The process for producing an optical article according to claim 4, wherein in the bonding layer forming step, the plasma-polymerized film is formed only on the optical functional film formed in the optical functional film forming step.
